(19) United States
(12) Patent Application Publication
(10) Pub. No.: US 2017/0128836 A1
(43) Pub. Date: May 11, 2017

(54) GAME CONTENT UNLOCK METHOD

(71) Applicant: ROVIO ENTERTAINMENT LTD., Espoo (FI)

(72) Inventors: Sami RONKAINEN, Espoo (FI); Miika TAMS, Espoo (FI)

(21) Appl. No.: 14/938,084

(22) Filed: Nov. 11, 2015

(51) Int. Cl. A63F 13/69

(52) U.S. Cl. CPC A63F 13/69

(57) ABSTRACT

The present invention relates to methods, systems and computer program products for promoting users to combine gaming experience with consuming media content. The invention further relates unlocking bonus content in a game application.

### BACKGROUND

Field

Examples of the present invention relate to promoting a movie utilizing a game application in a user device. More specifically, the examples of the present invention relate to methods, apparatuses, systems and related computer program products for combining gaming and movie experience.

Description of the Related Art

Some implementation exist, where additional content is provided to a user while watching e.g. a movie or broadcast content. For example a tablet device may be used to provide the additional information, which may be called as second screen experience. An audio recognition technology may be used to identify the content being watched and to detect which scene or moment in time the user is watching. Some implementations exist where the second screen experience is utilized in movie theatres, too. For example US20140237082 A1 discloses a system and method for delivering secondary content to movie theatre patrons for delivering secondary content to a plurality of user devices, the secondary content comprising events synchronized to primary content.

### SUMMARY

According to one example embodiment, a method is presented comprising embedding at least one media identifier in media content and running a game application in a user device where the game application comprises locked bonus content. The method further comprises detecting the embedded media identifier and unlocking the bonus content in the game application.

According to another embodiment computer program product is presented. When the computer program product is executed by one or more processors, it causes an apparatus to perform at least the steps for embedding at least one media identifier in media content and running a game application in a user device where the game application comprises locked bonus content. The method further comprises detecting the embedded media and unlocking the bonus content in the game application.

According to another embodiment a system is presented comprising embedding at least one media identifier in media content and running a game application in a user device where the game application comprises locked bonus content. The method further comprises detecting the embedded media identifier and unlocking the bonus content in the game application.

The present invention brings many advantages to enhancing user experience and providing means to combine gaming experience with movie experience. There has been some critique over second-screen experience implantations. Sometimes they are perceived to disturb the movie watching experience and their attractiveness among audiences is questionable. For example in implementation, where value promise is being able to access movie-related trivia or to read movie subtitles is high enough to attract users to go see the movie. Another issue is that the second screen experience is only relevant when watching the movie—there is little incentive to use an application providing the second screen experience when the user is not in the movie theatre or not watching a related broadcast.

In the current implementations the second screen experience requires network connection when being used. For example if the second screen provides more information about the actors, producers, directors, players etc. appearing in the media content the second screen application typically offers a link to a network resource for the additional information. Quite often there is no network connection in movie theatres and therefore the second screen cannot be used.

The current invention addresses these problems in novel fashion through combining the movie experience with gaming experience. Embodiments of the invention may involve creation system where a game application running in a user device promotes a movie and further detects if the game application is launched while watching the movie resulting locked bonus content to become unlocked, which bonus content may be utilized in the game application. The bonus content is preloaded in the game application requiring no network connection when the bonus content is unlocked.

Applicability of embodiments of the current invention can be demonstrated with a system comprising a user device for running the gaming application and multimedia content comprising identifier for detecting, which will be discussed in detail later in this document. Embodiments of the current invention provide significant contribution to the state of the art by improving the user experience for both gaming and watching a movie.

### BRIEF DESCRIPTION OF THE DRAWINGS

The embodiments of the invention are illustrated by way of example—not by way of limitation, in the figures of the accompanying drawings:

FIG. 1 illustrates a simplified arrangement where at least some example embodiments may be embodied.

FIG. 2 illustrates a block diagram of a game device.

FIG. 3 illustrates a block diagram of a server.

FIG. 4 illustrates a block diagram of a display device.

FIG. 5 illustrates a block diagram of a game application.

FIG. 6 illustrates a block diagram of a game application and a media content.

### DETAILED DESCRIPTION

The following embodiments are exemplary only. Although the description may refer to “an”, “one”, or “some” embodiment(s), this does not necessarily mean that each such reference is to the same embodiment(s), or that the feature only applies to a single embodiment. Single features of different embodiments may be combined to provide further embodiments.

In the following, features of the invention will be described with a simple example of a system architecture in which various embodiments of the invention may be implemented. Only elements relevant for illustrating the embodiments are described in detail. Various implementations of the information system comprise elements that are suitable for the example embodiments and may not be specifically described herein.

Example methods, systems, apparatuses and a computer program products are presented for enhancing user experience in gaming and in consuming media content.

As used herein, the term “user device” refers to a computing device and it may be for example a laptop, desktop computer, graphics tablet, cellular phone, media system of a vehicle, an electronic noticeboard, a television, or any other device with capabilities for running at least one application, like a game application and interacting with other computing devices. The user device may comprise a camera, a microphone and other components providing capability to detect identifiers surrounding the user device.

As used herein, the term “media content” refers to a content like a movie, a TV broadcast and other information and experiences directed to end-users or audience. The media content may be delivered via many different media including the internet, television, data storages like DVD, Blu-ray, memory cards etc. and also through live events, such as conferences and stage performances. Media content may further be for example a digital game events shown to an audience in a gaming event. It is to be understood that the media content can be broadly any kind of audio visual content displayed for an individual or an audience.

As used herein, the term “game application” refers to a proprietary application for gaming. The application software contains such instructions that, when executed by one or more processors, causes a computing device to perform tasks. The game application may also be referred as software application, application program, application software, app and so on. It is to be noted that in at least some of the example embodiments also system software providing a platform for running the application can be considered functionally similar to the game application. Alternatively, or in addition to, also set of instructions based on HTML5 mark-up language may be considered as a game application. The application may be used on a computing device, in several computing devices, on a server or several servers and it may utilize cloud computing. In addition the game application may comprise means for interpreting detected identifiers from surroundings of the user device, in which the game application is running.

The game application may store a game state for a user in locally in the user device or remotely on a server. The game state comprises several game and user related parameters, like status of the game, status of the player (user), gained in-game assets (awards, skills, loots . . . ) and so on. The game state may include information which levels the user has managed to open for example by succeeding on the lower levels of the game.

As used herein, the term “bonus content” refers to digitally encoded data stored in the game application. The bonus content may for example comprise video content, audio content, textual content, image content etc. The bonus content may further comprise in-game assets (awards, rewards, loots . . . ), which can be achieved for example by succeeding in the game, promoting the game or purchasing them. In-game assets may include points, virtual coins, game character levels, game levels, skills, tools, weapons and so on.

As used herein, the term “media identifier” refers to a digital identifier embedded in media content. The media identifier may be embedded for example using audio watermark or other suitable technology. Audio watermarking is typically used to identify ownership of copyright but it can be used for other purposes, too. Audio watermarking may include techniques like spread spectrum audio watermarking, in which a narrow-band signal is transmitted over a larger bandwidth such that the signal energy presented in any frequency is undetectable. There may be several different watermarks embedded in the media content for different purposes. Ideally, the embedded watermarks are inaudible by humans. The audio watermark can be converted into strings of characters, like letters and numbers.

The media identifier may also be embodied with visual identifiers, which are machine readable optically. For example the visual identifiers may be barcodes varying the widths and spacing of parallel lines (1D). Barcodes may also be rectangles, dots, hexagons and other geometric patterns in two dimensions (2D). Visual identification can also be constructed without identifiers visible to the user. A software in a user device may recognize various aspects in the media content, like shapes, lightning, colors etc.

As used herein, the term “server” refers to a physical or virtual computational entity capable of enhancing information and to perform computational tasks. The term server may refer to one entity or a group on entities configured to operate jointly with capabilities for running an application and interacting with at least one user device.

While various aspects of the invention are illustrated and described as block diagrams, message flow diagrams, flow charts and logic flow diagrams, or using some other pictorial representation, it is well understood that the illustrated units, blocks, device, system elements, procedures and methods may be implemented in, for example, hardware, software, firmware, special purpose circuits or logic, a computing device or some combination thereof.

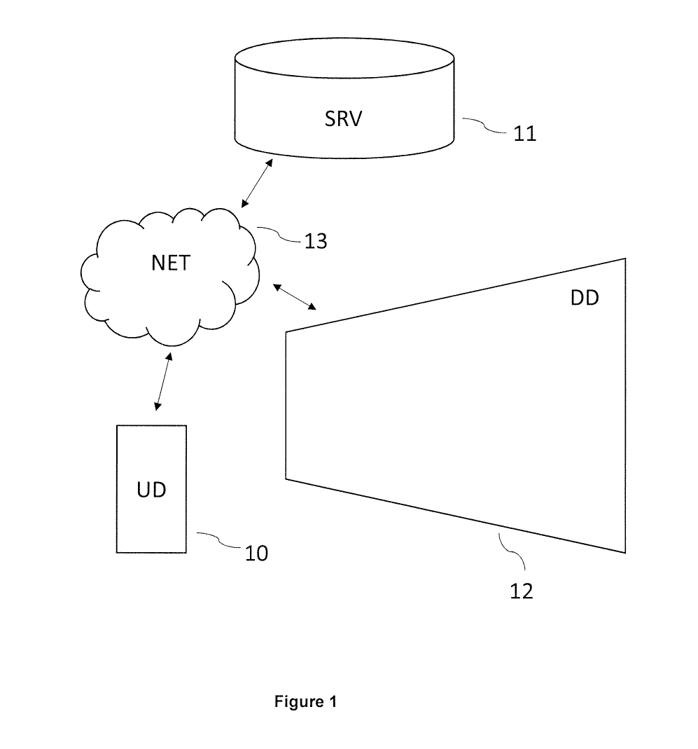

FIG. 1 is a simplified diagram of a system, where embodiments of the current invention may be implemented. Only one user device (UD) 10 is depicted but in practise there may be a large number of those in the system. Display device (DD) 12 represents various kinds on devices from household devices, like television monitors, computers, home theatre systems etc. to movie theatres and devices used in live concerts and so on. The display device 12 has capabilities to play the media content with the embedded media identifier. The display device 12 may further have capabilities to store the media content in a memory.

Server (SRV) 11 stores and exchanges information between various entities in the system. It may for example store information relating to the media content, the media content essence data and so on. The server 11 may further store information relating to the game application and/or the user.

The network 13 may comprise, for example, a personal area network, a local area network, a home network, a storage area network, a campus network, a backbone network, a metropolitan area network, a wide area network, an enterprise private network, a virtual private network, or a combination of any of these.

The example network system of FIG. 1 is a simplified illustration depicting one user device 10, one server 11 and one display device 12. The number of the elements may vary and in some example embodiments some of the elements may be non-existing and functionalities of the two or more elements may be embodied in one element.

FIG. 2 illustrates a simplified example block diagram of the user device 10. The user device 10 comprises at least one game application 20 (G-APP), which can be any kind of application or a set of applications running at least partly on the user device 10. The user device 10 may further comprise a memory 21 (MEM) for storing the game application 20 and other information. The memory 21 may comprise volatile or non-volatile memory, for example EEPROM, ROM, PROM, RAM, DRAM, SRAM, firmware, programmable logic, etc. The user device 10 may further comprise one or more processor units 22 (CPU) for running the game application 20 and other applications, a user interface 23 (UI) for giving instructions to the computer programs and presenting information to a user and an interface 24 (IF). In addition the user device 10 may comprise various input/output and other components like a battery, microphone, speakers, display typical for example for a smart phone or a tablet device which are not illustrated in FIG. 2.

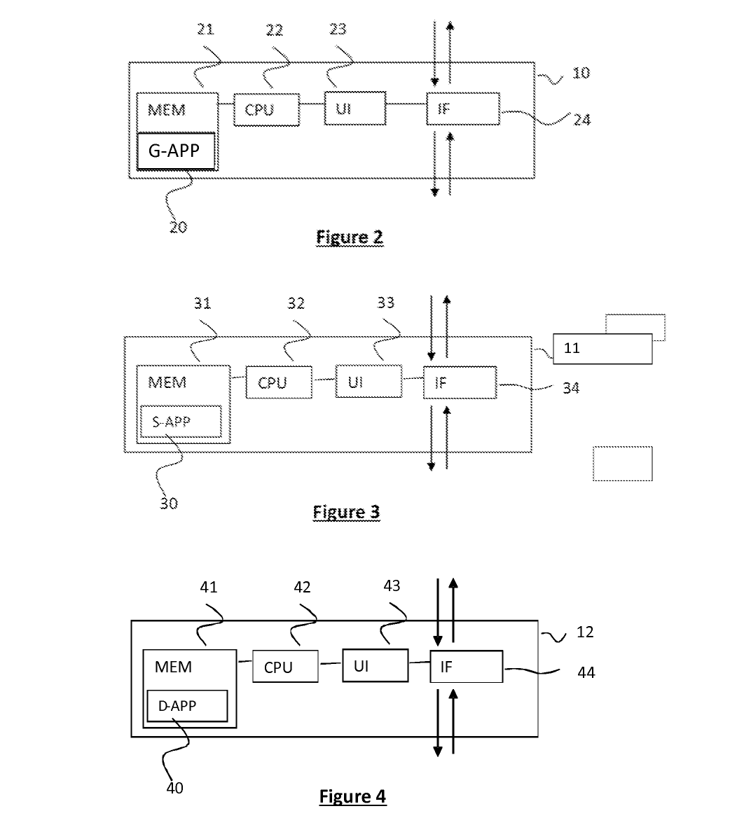

FIG. 3 illustrates a simplified example block diagram of the server 11. The server 11 may comprise a memory 31 (MEM) for storing a server application 30 (S-APP). The memory 31 may comprise volatile or non-volatile memory, for example EEPROM, ROM, PROM, RAM, DRAM, SRAM, firmware, programmable logic, etc. The server 11 may further comprise one or more processor units 32 (CPU) for processing instructions and running computer programs, like the server application 30, and an interface unit 34 (IF) for sending and receiving messages.

FIG. 4 illustrates a simplified example block diagram of the display device 12. The display device 12 may comprise a memory 41 (MEM) for storing a display device application 40 (D-APP). The memory 41 may comprise volatile or non-volatile memory, for example EEPROM, ROM, PROM, RAM, DRAM, SRAM, firmware, programmable logic, etc. The display device may further comprise one or more processor units 42 (CPU) for processing instructions and running computer programs, like the display device application 40, and an interface unit 44 (IF) for sending and receiving messages.

One target of the current invention is to create a method combining gaming experience with a movie experience. Let us consider a use-case example:

Functionality for detecting a media identifier in media content is included in a game application 20 installed on a user device 10. For example the game application may analyse audio received via microphone of the user device 10. The media identifier may be for example an audio watermark. The game application 20 comprises locked content, which is not available for the user to use.

The media identifier may be embedded to the audio of the media content in many ways. As an example an audio watermark is embedded to the movie so that it can be detected at certain time period or at any time when the movie is being played. Presence of the media identifier may be indicated to users in many ways. For example an icon or a text string may be added to the media content video or it may be identified via audio, too. The game application may remind the user to launch a game while the user is for example in a movie theatre watching the media content.

In some embodiments the media identifier may be for example embedded to the audio string played during the opening credits or the closing credits of the media content. Having the media identifier during the credits may have some benefits in some embodiments. For example an icon identifying the presence of the media identifier is less disturbing compared to displaying the icon during the actual media content like a movie. On the other hand, in some embodiments it may be beneficial to include the media identifier in certain part of the media content, where it supports the story.

In some embodiments the media identifier may be added to a suitable moment of the media content audio, for example when there is not much other sound played. In some situations it may help the game application running in the user device to detect the media identifier.

In some embodiments the media identifier may be added to another suitable moment of the media content audio, for example when there is plenty of other sound played, when there is more options to modulate the sound spectre.

In some embodiments the media identifier may be added to the content media audio periodically from start to finish, when the game application is able to detect it in any phases of the media content. Different media identifiers may appear in different parts of the media content.

In some embodiments the media identifier may be audible for humans, too.

The game application may advertise on the user device 10 via the game application. For example the game application may inform the user that there is an upcoming movie in a movie theatre soon and playing the game application at the movie theatre, while the movie is being played, will grant an award—unlocking the locked content. The award (locked content) may be for example a new game character, exclusive content, access to a new level, game points etc. Having the locked content ready in the game application (in the memory 21 of the user device 11) is beneficial especially when there is no network connection available, which is the case often in movie theatres.

The game application may further instruct the user to activate the game application at a desired moment. The game application utilizes the functionality of detecting the audio watermark embedded in the movie audio and the locked content is unlocked.

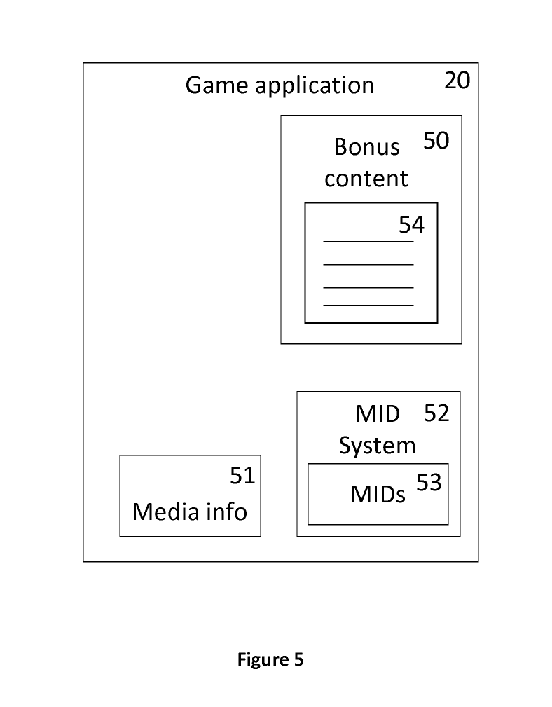

FIG. 5 depicts one example embodiment of the game application 20. The game itself can be of any kind of game genre. For example a racing game, fighting game, maze game, shooting game, platform game, action game, adventure game, construction game, strategy game and so on. Typical for the games for certain implementations of the current invention is to have a structure where the user (player) is able to proceed in the game and gain in-game rewards, here called bonus content 50. The game application may be stored on the memory 20 of the game device 10, on memory 30 of the server 11 or several servers 11 or partly on any of those.

The bonus content 50 refers to locked or unlocked content relating to a game or games. The bonus content 50 may comprise various in-game assets 54 as described earlier for example game levels. The bonus content 50 may be installed into the game device 10 at the same time when the game application 20 is installed or when the game application is launched for the first time. The bonus content 50 may be installed in practice anytime but it will be installed before certain embodiments of the current invention may be carried out. Several pieces of the bonus content 50 may be locked or unlocked individually.

Media identification system 52 comprises a set of functionalities including receiving recorded audio from an interface unit 24 of the game device 10, analysing the recorded audio and detecting an audio watermark in the audio. The media identification system 52 may comprise a set of media identifiers 53 (MIDs), which is a list of pre-defined media identifiers to be embedded in the media content. The media identifiers 53 may be arranged to be in the game either directly in the installation package (in app store) or downloaded right after end user installation when the application starts.

The media identification system 52 may be active always when the game application 20 is running, when the game application 20 is being used or activated for example from a menu in the game application 20.

The game application 20 may further comprise media info 51, which relates to the media content and/or availability of the media content. In an example embodiment, where a movie is considered the media info 51 may comprise information about release date in the user's country, information about the movie theatres where the movie is shown, dates and times when the movie is played in a movie theatre, availability and prices of tickets etc. Can be integrated in the game (as a list of dates, selected when the game knows the user's geolocation) or as downloaded content, geo-targeted to the player's location and updated whenever there is an internet connection.

According to one embodiment area specific media info 51 is selected and downloaded based on the country, where the game is installed or launched for the first time. According to another embodiment all media info 51 (for any area, town, country . . . ) is installed and only the relevant information is selected to be used based on location information, IP-address or other suitable method.

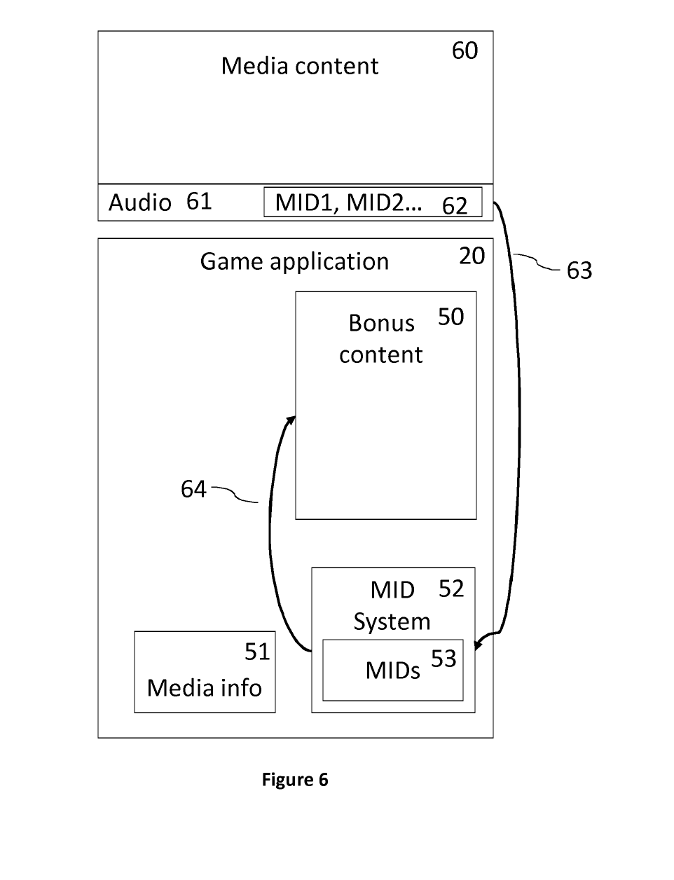

FIG. 6 depicts the media content 60, audio 61 of the media content 60 and two media identifiers 62 (MID1 and MID2). At least one media identifier 62 may be embedded to the audio at any suitable phase of the movie production. According to one embodiment the at least one media identifier 62 is embedded into so called print master version. The media identifier 62 may be embedded for example into music and effects soundtrack. In some cases there will be different language variants for the movie and it may be more robust to embed the media identifier 62 in to a moment where no speech is present.

According to another embodiment the media identifier 62 is embedded to the langue variant audio soundtrack. In this solution different media identifiers 62 could be assigned for different language variants.

According to another embodiment different media identifiers can be embedded to media content 60 according depending on the essence where it is stored. For example DVD, Blu-ray, movie theatre releases could have different media identifiers 62 and further different functionalities assigned to those. Furthermore different media identifiers 62 may be assigned to different retailers like stores, movie theatres etc.

FIG. 6 further depicts one example embodiment of the current invention. The game application 20 displays media info 51 to the user, for example promoting a movie premiering soon in a movie theatre near the user. The user may also be informed about bonus content available at the movie theatre, while watching the movie. The user decides to go to the movie theatre to see the promoted movie. While in the movie theatre the user may be instructed to launch the game application 20. The movie is shown the media identification system 53 detects 63 a media identifier 62 and compares it to stored media identifiers 53 or information relating to those. In case there is a match the respective bonus content is unlocked 64.

In another example embodiment detecting the same media identifier 53 more than once unlocks more bonus content 50. The user may watch a movie more than once and get an in-game reward every time. Furthermore the user may watch the same media content on different media (movie theatre, DVD, broadcast, streaming. . . ) and receive in-game rewards every time.

It is apparent to a person skilled in the art that as technology advances, the basic idea of the invention can be implemented in various ways. The invention and its embodiments are therefore not restricted to the above examples, but they may vary within the scope of the claims.

1. A method comprising:
embedding at least one media identifier in media content;
running a game application in a user device, the game application comprising locked bonus content;
detecting the embedded media identifier;
unlocking the bonus content in the game application.

2. The method of claim 1, wherein the media content is a movie.

3. The method of claim 2, wherein the movie is played in a motion picture theatre.

4. The method of claim 1, wherein the media identifier is an audio watermark.

5. The method of claim 1, wherein the method further comprises the game application promoting the media content.

6. The method of claim 5, wherein the method further comprises the game application to instruct activating the game application while consuming the media content.

7. The method of claim 1, wherein the bonus content includes awards relating to the game application.

8. A computer program product, when executed by one or more processors, cause an apparatus to perform at least the steps for:
embedding at least one media identifier in media content;
running a game application in a user device, the game application comprising locked bonus content;
detecting the embedded media identifier;
unlocking the bonus content in the game application.

9. The computer program product of claim 8, wherein the media content is a movie.

10. The computer program product of claim 9, wherein the movie is played in a motion picture theatre.

11. The computer program product of claim 8, wherein the media identifier is an audio watermark.

12. The computer program product of claim 8, wherein the method further comprises the game application promoting the media content.

13. The computer program product of claim 12, wherein the method further comprises the game application to instruct activating the game application while consuming the media content.

14. The computer program product of claim 8, wherein the bonus content includes awards relating to the game application.

15. A system comprising:
means for embedding at least one media identifier in media content;
means for running a game application in a user device, the game application comprising locked bonus content;
means for detecting the embedded media identifier;
means for unlocking the bonus content in the game application.

16. The system of claim 15, wherein the media content is a movie.

17. The system of claim 16, wherein the movie is played in a motion picture theatre.

18. The system of claim 15, wherein the media identifier is an audio watermark.

19. The system of claim 17, wherein the method further comprises the game application promoting the movie.

20. The system of claim 19, wherein the method further comprises the game application to instruct activating the game application while consuming the media content.
